(19) United States
(12) Patent Application Publication
(10) Pub. No.: US 2023/0027583 A1
(43) Pub. Date: Jan. 26, 2023

(54) METHOD OF PREPARING AND PACKAGING A FOOD PRODUCT

(71) Applicant: Stampede Meat, Inc., Bridgeview, IL (US)

(72) Inventor: Dennis Gruber, Homer Glen, IL (US)

(73) Assignee: Stampede Meat, Inc., Bridgeview, IL (US)

(21) Appl. No.: 17/382,538

(22) Filed: Jul. 22, 2021

(51) Int. Cl. A23L 13/70; A23L 5/10; A23B 4/044; A23L 13/00; A23L 19/00; B65D 81/20; B65D 81/34

(52) U.S. Cl. CPC A23L 13/72; A23B 4/044; A23L 5/13; A23L 13/03; A23L 19/05; B65D 81/2007; B65D 81/3438; A23V 2002/00

(57) ABSTRACT

One or more methods are disclosed to provide for the preparation of a food product that can be quickly cooked, while exhibiting flavors, textures, and colors of more traditional and time consuming cooking methods. The method produces a food product with the full flavor profile of barbeque, with the ease of a ready-made meal. The preparation prior to packaging facilitates a Maillard reaction and carmelization of the food product. The method can include marinating the food product, searing an outside portion of the food product, smoking the food product, vacuum sealing and then cooking the food product using a sous vide method. The prepared food product can then be easily heated by the end user for consumption.

### BACKGROUND

Pre-packaged readymade food products have become increasingly popular due to increased shelf-life and convenience of preparation. These readymade meals are usually refrigerated, and then quickly heated prior to eating. Unfortunately, this type of quick heating usually leaves food lacking the flavors that are developed during more conventional cooking methods. For example, using a microwave device to quickly heat meat fails to produce the sear and complex flavors associated with barbequing or smoking meat.

This is due to the Maillard reaction and carmelization. The Maillard reaction is a chemical reaction between a carbonyl group of a sugar molecule and an amino group of an amino acid, which produces odor and flavor molecules in food. Carmelization is the oxidation of sugar, resulting in a nutty flavor and a brown color. Both of these chemical reactions are facilitated by certain levels of heat over a given period of time. Microwaving and other methods of quick heating are not often able to meet time or temperature needed for these reactions to occur. Accordingly, pre-packaged readymade food products are not typically as flavorful as food products cooked using conventional methods. Therefore, a method of preparing and packaging readymade food products that uphold the flavor of conventional cooking methods is desirous.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein are provided that can be used to help prepare and package a food product. In one implementation a method of preparing a meat product is disclosed comprising marinating the meat, applying heat to the meat to form a sear, smoking the meat, vacuum sealing the meat, and sous vide cooking the vacuum sealed meat.

In another implementation a method of preparing a meat product is disclosed comprising marinating the meat, applying heat to the meat to form a sear, smoking the meat, vacuum sealing the meat, sous vide cooking the vacuum sealed meat, breaking the vacuum seal, and heating the meat.

In yet another implementation a pre-packaged meat product is disclosed comprising a vacuum sealed meat, wherein prior to the vacuum seal the meat was marinated, seared, and smoked, and wherein after the meat was vacuum sealed the meat was sous vide cooked in steam.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is flow chart illustrating an exemplary implementation of a method of preparing and packaging a food product.

FIG. 2 is a flow chart illustrating an exemplary implementation of a method of preparing pre-packaged meat for consumption.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

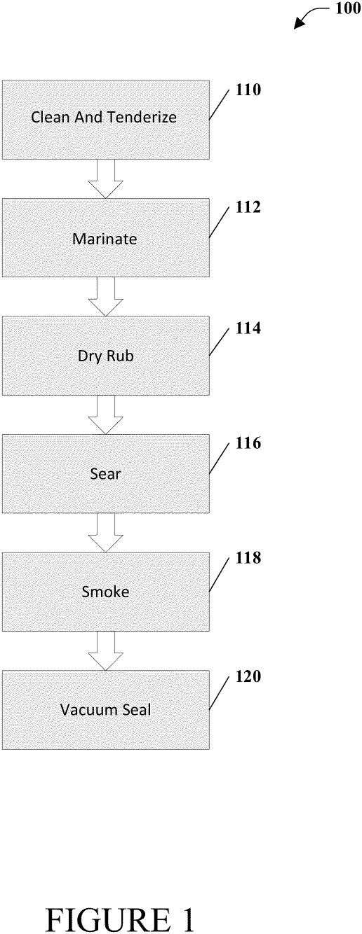

FIG. 1 illustrates one implementation of a method 100 for preparing and packaging a food product. In one implementation, the food product is meat (beef, pork, poultry), however, the food product may also be plant-based , such as fruit or vegetables (asparagus, broccoli, cauliflower, brussel sprouts, mushrooms, carrots, eggplant, jack fruit, pineapple, apples, etc.) or a plant-based protein (containing fruits and/or vegetables with plant-based protein, such as soy, oats, quinoa, lentils, chickpeas, edamame, etc.). In one implementation, the food product is meat and at 110, the meat is raw, and/or kept at a temperature between 20° F. to 75° F., 26° F. to 55° F., 32° F. to 40° F., or between 36° F. to 38° F. Here, the meat may be cleaned 110, which may include removing unwanted parts from the meat, such as bones, nerves or tendons, and fat. This may be accomplished by “trimming” or cutting the unwanted parts away from the meat with a knife or similar object. When cleaning the meat, the meat may also be cut, if desired, into smaller portions such as cubes, strips, filet, drumstick, wing, thigh, breast, primal cuts (brisket, foreshank, rib, chuck, flank, long loin, hip, sirloin tip) subprimal cuts (short rib, 7-bone rib, neck, blade, shoulder, cross rib, brisket point, brisket plate, short loin, sirloin butt, inside round, outside round, hind shank), or any other desired shape. This cutting may mitigate uneven cooking later in the process.

In another implementation, the food product is plant-based. The plant-based product may be a At 110, the plant-based product is raw, and/or kept at a temperature between 20° F. to 75° F., 26° F. to 55° F., 32° F. to 40° F., or between 36° F. to 38° F. Here, the plant-based product may be cleaned 110, which may include washing the plant-based product to remove dirt or other contaminants and removing unwanted parts from the plants, such as leaves, stems, or roots. This may be accomplished by rinsing the plant-based product with water, and then cutting the unwanted parts away from the plant with a knife or similar object. When cleaning the, the plant-based product may also be cut, if desired, into smaller portions such as cubes, slices, batonnets, or any other desired shape. This cutting may mitigate uneven cooking later in the process.

In yet another implementation, the food product is raw beef, such as brisket, and may be trimmed by separating the point cut (a thicker area of the meat marbled with fat and connective tissue) from the flat cut (a thinner and larger area of the meat than the point cut, with a thick layer of fat). The point cut may be separated from the flat cut by making a vertical incision from the top of the brisket to the bottom exposing a fat seam that separates the point cut from the flat cut. In this implementation, the fat may be trimmed to a thickness of about (± 0.25) 0.25 of an inch. The meat may be cut into about (± 0.25) 2 inch strips lengthwise, which may be further cut into about (± 0.25) 1.5 inch to 2 inch cubes. If the natural thickness of the cubes is greater than about 2.5 inches, the cubes may be cut in half. Preferably, the cubes may have dimensions of 1.5 inches to 2 inches by 1.5 inches to 2 inches. It should be appreciated that similar trimmings may be made for pork, chicken, turkey, and other types of meat, that results in removing the fat from the meat and cutting the meat into smaller portions.

When the food product is meat, during or after cleaning, the meat may be tenderized 110. Tenderizing entails softening the meat (e.g., breaking connective tissue, fat, muscle, proteins, etc. apart), for example, making it easier to chew. In one implementation, the meat is mechanically tenderized and kept at a temperature between 26° F. to 65° F., 32° F. to 40° F., or 36° F. to 38° F. Mechanical tenderization may utilize pounding, or piercing the meat to break down the connective tissues within the meat. In other implementations, other tenderizing techniques such as thermal tenderization or enzymatic tenderization may be used. Thermal tenderization may utilize heating the meat slowly to a steady temperature and holding the meat at the temperature for an extended period of time, which also results in the break-down of connective tissues within the meat. Enzymatic tenderization may utilize adding enzymes to the meat that break down the connective tissues over time.

After tenderizing for meat, or after cleaning for plants, the food product may be marinated 112. During marinating, the food product may be introduced to a variety of wet ingredients. The wet ingredients may include dry components. In one implementation, the food product is meat and the wet ingredients may include 45%-65% (wt. %) water, 10%-30% (wt. %) beef juice treated with a preservative such as sodium metabisulfite, 2%-22% (wt. %) various seasonings, 1%-7% (wt. %) sodium bicarbonate, 1%-7% (wt. %) salt, 1%-7% (wt. %) tate and lyle corn starch, and 1%-7% (wt. %) vegetable oil.

In yet another implementation, marinating the food product in wet ingredients may be completed using a vacuum tumble or an injector. The food product may be kept at a temperature between 26° F. to 60° F., 32° F. to 40° F., or 36° F. to 38° F. Vacuum tumbling is a process where the food product and wet ingredients are introduced into a drum, and the drum is sealed and at least a portion of the air is removed (e.g., negative air pressure is applied), forming a vacuum. Either as the vacuum is formed, or after the vacuum is formed, the drum rotates, tumbling the food product and wet ingredients around the inside of the drum, coating the food product with the wet ingredients. For meat, the drum may also contain fins, paddles, mixers, or other objects that act as mechanical tenderizers to the meat, as a result of the meat impacting the fin when the drum rotates. As an example, in some implementations, if the drum also tenderizes the meat, the tenderizing step of 110 may be skipped. Injection marinating involves a syringe-like tool used to impregnate the wet ingredients into the food product. The syringe-like tool may be inserted into the food product, and the wet ingredients can be inj ected/released inside the food product. It should be appreciated that other marinating techniques may be used, such as soaking. Soaking entails merely placing the food product in contact with the wet ingredients for a set period of time.

After marinating the food product with the wet ingredients 112, the food product be introduced to a variety of dry ingredients 114. The dry ingredients may include wet components. In one implementation, the food product is meat, which may be marinated with dry ingredients including 0.5%-5% (wt. % of the meat) dextrose, 0.1%-3% (wt. % of the meat) curing powder (a combination of salt, sugar, nitrite, and/or nitrate), and 0.05%-3% (wt. % of the meat) beet powder. It should be appreciated that other dry ingredients may be used in various quantities to achieve the desired flavor profiles.

In another implementation, the food product may be introduced to the dry ingredients using a rubbing process all while kept at a temperature between 26° F. to 60° F., 32° F. to 40° F., or 36° F. to 38° F. When rubbing, the dry ingredients are placed on the outer surface of the food product and rubbed into the surface, causing the ingredients to stick to the surface of the food product. However, in other implementations, the dry ingredients may be introduced to the food product using any suitable means, such as tumbling, pouring, etc. During tumbling, the dry ingredients are placed inside a container with the food product, and the food product and dry ingredients are tumbled, rotated, or shaken, to distribute the dry ingredients along the outer surface of the food product. During pouring, the dry ingredients are merely poured on top of the food product.

The marinated and rubbed food product may then be heated 116 to form a sear on the food product’s outer surface. During the searing process, the dry ingredients on the outer surface of the food product may chemically react with the food product in the presence of heat to influence the flavor and color of the food product through a Maillard reaction and carmelization. In one implementation, the food product is pan seared with oil, where the oil and pan reach a temperature of 300° F. to 400° F., for a period of time that keeps the internal temperature of the food product between 32° F. to 144° F. In another implementation, the food product is beef brisket that is cubed, and the period of time for oil searing at 375° F. is about (± 0.25) 2.5 minutes. In yet another implementation, the food product is deep fried with oil, where the oil reaches a temperature of 300° F. to 400° F., for a period of time that keeps the internal temperature of the meat between 32° F. to 144° F. In another implementation, the food product is beef brisket that is cubed, and the period of time for deep frying at 375° F. is about (± 0.25) 2.5 minutes.

When searing with oil, any suitable oil may be used, such as avocado oil, mustard oil, extra light olive oil, peanut oil, soybean oil, refined olive oil, canola oil, vegetable shortening, butter, extra virgin olive oil, tallow, oil based smoke, smoke flavor mixed with oil, etc. In other implementations, other types of sear methods may be used, such as simply pan searing without oil, grilling, baking, etc. In each type of sear, the food product is introduced to heat until a brown crust forms on the outer surface of the food product, signaling carmelization and the Maillard reaction.

After searing 116, the rubbing step 116 may be repeated, or the food product may be smoked 118. In one implementation, the food product may be placed on an open air rack within a chamber where smoke from the heating of wood chips is introduced at a temperature of 135° F. to 165° F. and fills and circulates throughout the chamber, while keeping the internal temperature of the food product between 32° F. to 144° F., more preferably 130° F. to 144° F.

During smoking 118, the temperature, smoke levels, and humidity levels may be increased or decreased as desired, such as to alter flavor, change heat setting, speed or slow the process. In one implementation, the food product may be cooked between 120° F. to 200° F., more preferably between 130° F. to 150° F. within the chamber without any smoke or humidity for 20 minutes to 40 minutes, then smoked at 130° F. to 150° F. at humidity levels of greater than 0%, more preferably at 50% humidity for 3.5 hours to 4.5 hours, then smoked at 155° F. to 165° F. for 10 minutes to 25 minutes, and then held at 140° F. for 10 minutes to 30 minutes. After smoking, the temperature of the food product may be rapidly lowered to 26° F. to 60° F., 32° F. to 40° F., or 36° F. to 38° F. by refrigeration or other chilling means.

Any suitable wood chips may be used during smoking, such as oak wood chips, maple wood chips, hickory wood chips, mesquite wood chips, pecan wood chips, apple wood chips, cherry wood chips, alder wood chips, etc. The food product is strategically placed to be heated and flavored by the smoke, with the flavoring being influenced by the type of wood chips used. It should be appreciated that other methods of smoking may also be used.

In another implementation, included with the wood chips during smoking 118 may be cannabidiol (“CBD”) oil. The CBD oil may in in the form of broad spectrum CBD or full spectrum CBD. Broad spectrum CBD oil, also referred to as CBD distillate, is CBD extracted from hemp flowers in a highly-purified and refined form. Here, highly-purified and refined means stripped of almost all other materials and compounds through distillation processes that separate compounds from cannabis plant matter. Broad spectrum CBD is made of primarily, if not entirely CBD. For example, the broad spectrum CBD may be made of 90%-100%, 92%-99%, 94%-98%, or 96%-99% CBD, and the remaining 0%-10%, 1%-8%, 2%-6%, or 1%-4% of trace other cannabinoids and plant matter, such as THC. The THC level may be at 0%-3%, 0.1%-3%, 0.2%-3%, or 0.25%-3% of the full spectrum CBD.

Full spectrum CBD oil is CBD extracted from the hemp plant that is not distilled. This results in full spectrum CBD having other cannabinoids besides CBD, including THC. For example, full spectrum THC may be made of 5%-89%, 15%-85%, 25%-80%, 35%-75%, 45%-70%, 55%-75%, 65%-80%, 75%-85%, or 85%-89% CBD, and the remaining 11%-95%, 15%-85%, 20%-75%, 25%-65%, 30%-55%, 25%-45%, 20%-35%, 15%-25%, or 11%-15% of trace other cannabinoids and plant matter, such as THC. The THC level may be at 0%-3%, 0.1%-3%, 0.2%-3%, 1%-95%, 5%-90%, 15%-80%, 25%-75%, 40%-85%, 55%-65%, or 65%-89% of the full spectrum CBD.

The CBD oil may be added to the wood chips in pre-packaged portions, it may be drizzled onto the wood chips, or the wood chips may be soaked into the CBD oil. CBD oil that is pre-packaged may be packaged in a flammable container or wrapper in the desired amount, where the entire package may be added to the wood chips. The pre-packaged amount may contain 0.25-5 teaspoons, 0.5-4.75 teaspoons, 0.75-4.50 teaspoons, 0.90-1.10 teaspoons, or 0.90-2.10 teaspoons of CBD. CBD oil that is drizzled may be lightly poured over top of the wood chips. Wood chips that are soaked in CBD oil may be submerged into the CBD oil and then placed into the smoker. Whether using pre-packaged portions, drizzling, or soaking, CBD oil may be added at a rate of about (±0.10) 1 teaspoon of CBD oil to about (±0.25) 1 cup per about (±0.20) 2 cups of wood chips. It should be appreciated that more or less CBD oil may be added depending on the desired flavor profile.

As the CBD oil heats with the wood chips, it may begin to boil and vaporize, forming a vapor. The vapor may then join the smoke of the wood chips, heating and flavoring the food product. The food product may then contain levels of CBD or any of the other present cannabinoids, such as THC. The THC level may be 0%-3%, 0.1%-3%, 0.1%-5%, or 0.1%-7% of the food product.

After the food product is smoked 118, it may be packaged and vacuum sealed 120. In some implementations, the food product can be rapidly cooled prior to packaging, by bringing the temperature of the food product to 26° F. to 60° F., 32° F. to 40° F., or 36° F. to 38° F. by refrigeration or other chilling means. The refrigeration or rapid cooling means may entail lowering the internal temperature of the food product within 90 minutes of the end of the smoking process 118 to 26° F. to 60° F., more preferably to about (±5°) 55° F. in 6 or less hours. The internal temperature of the food product may then be continuously lowered until it reaches 26° F. to 50° F., more preferably to about (±5°) 40° F. The rapidly cooled food product may then be packaged. In other implementations, the food product can be packaged at the temperature encountered at the end of the smoking process. The packaging may be any suitable material, such as a plastic/polymer-based product, that is flexible enough to form around the food product when air is removed from the packaging. In one implementation, the food product may be placed in the packaging and the packaging vacuum sealed, removing practically all air from within the packaging. To mitigate microbiological growth, the food product should be packaged and vacuum sealed or rapidly cooled before the internal temperature of the food product drops more than 10° F. from the smoking temperature.

The vacuum sealed food product may then be rapidly cooled or heated by steam to cook the food product in a sous vide style. In one implementation, the vacuum sealed food product is rapidly cooled by bringing the temperature of the food product to 26° F. to 60° F. , 32° F. to 40° F., or 36° F. to 38° F. by refrigeration or other chilling means. The refrigeration or rapid cooling means may entail lowering the internal temperature of the food product within 90 minutes of the end of the smoking process 118 to 26° F. to 60° F., more preferably to about (±5°) 55° F. in 6 or less hours. The internal temperature of the food product may then be continuously lowered (chilled) until it reaches 26° F. to 50° F., more preferably to about (±5°) 40° F. The vacuum sealed chilled meat may then be heated by sous vide within 90 days of chilling. In another implementation, the vacuum sealed food product is heated by steam to cook the meat in a sous vide style. Sous vide cooking entails sealing food in an airtight container, and then cooking the food in the airtight container in a temperature-controlled fluid, such as liquid water or steam. In one implementation, the internal temperature of the vacuum sealed food product may be heated by steam to 120° F. to 216° F., and held for up to 24 hours, including the time it takes for the internal temperature of the meat to reach the desired temperature (1 hour to 2 hours). After sous vide cooking, the food product should reach at least a Log (logarithm) 7 reduction. A Log reduction is the difference between the amount of microbiological colony forming units (CFUs) of the raw food product, and the amount of CFUs of the sous vide cooked food product. After cooking, the temperature of the vacuum sealed meat may be brought to (e.g., lowered to) 26° F. to 60° F. , 32° F. to 40° F., or 36° F. to 38° F. by refrigeration or other chilling means. As an example, after this preparation step, the vacuum sealed food product may then be stored for at least 60 days at temperatures of about (±5°) 40° F., and at least 365 days at temperatures of about (±5°) 0° F. without compromising the quality or integrity of the food product.

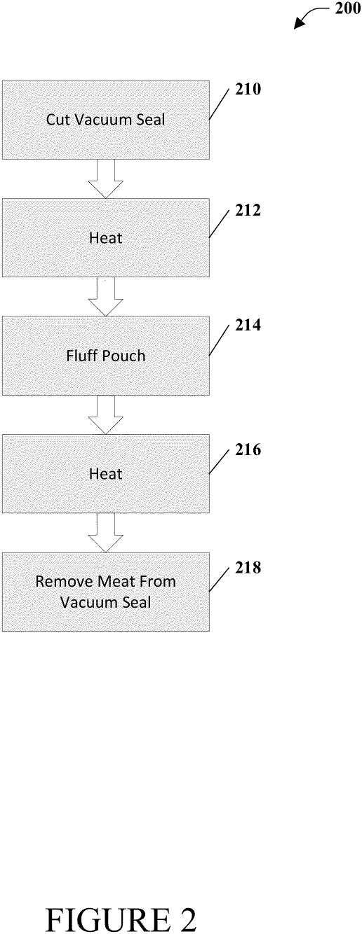

FIG. 2 illustrates one implementation of a method 200 of preparation of the vacuum sealed food product of the previous embodiments by an end user. In this implementation, the end user can begin by cutting a slit in the vacuum seal packaging 210, thus breaking the vacuum seal, and heating the food product within the packaging 212. In one implementation, a microwave oven can be used to heat the food product. The microwave oven may heat the meat for 2.5 minutes on high heat, or about (±15°) 212° F. After heating 212, the food product within the pouch should be redistributed 214 to separate the food product. The food product should then be heated again 216. In one implementation, the food product is heated again 216 in a microwave oven. In this implementation, the food product may stay within the vacuum seal packaging and be heated for 2.5 minutes on high heat, or about (±15°) 212° F. After heating, the food product may be removed from the packaging and served. In another implementation, the food product is heated again 216 on a stove top on medium heat, or between 300° F. and 400° F. In this implementation, about (±0.25) 1 tablespoon of cooking oil may be poured in a skilled on a stove top over medium heat. The food product may then be removed from the vacuum seal packaging and placed in the skillet. After about (±15) 45 seconds, the food product may be flipped, and heated on the opposing side for about (±15) 30 seconds. The food product may then be removed from the skillet and served for eating. In another implementation, the food product can be heated by placing it in a pot of heated (e.g., boiling) water, at least until the food product is thoroughly heated through.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter comprises been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure comprises been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “comprises,” “having,” “comprises,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A method for preparing a meat product, the method comprising:
marinating at least one piece of meat;
applying heat to form a sear to at least an outer surface of the at least one piece of meat;
smoking the at least one piece of meat;
vacuum sealing the at least one piece of meat;
sous vide cooking the vacuum sealed meat.

2. The method of claim 1, wherein marinating further comprises introducing the at least one piece of meat to wet ingredients, the wet ingredients absorbing into the meat.

3. The method of claim 2, wherein marinating further comprises introducing the at least one piece of meat to dry ingredients, the dry ingredients coating at least an outer surface of the at least one piece of meat.

4. The method of claim 1 further comprising tenderizing the meat through mechanical tenderization.

5. The method of claim 1 further comprising collecting juices emitted by the meat during smoking, and introducing at least some of the collected juices to the smoked meat in a manner that causes the meat to absorb at least some of the collected juices.

6. The method of claim 3, wherein the applied heat causes a Maillard reaction and between the dry ingredients and the meat.

7. The method of claim 1, wherein the temperature of the meat is lowered to within a predetermined temperature range after smoking and after sous vide cooking.

8. The method of claim 1, wherein vacuum sealing further comprises lowering the temperature of the at least one piece of meat to within a predetermined temperature range.

9. A method for preparing a food product, the method comprising:
marinating at least one piece of food product;
applying heat to form a sear to at least an outer surface of the at least one piece of food product;
smoking the at least one piece of food product;
vacuum sealing the at least one piece of food product;
sous vide cooking the vacuum sealed food product;
breaking the vacuum seal;
heating the food product.

10. The method of claim 9, wherein marinating further comprises introducing the at least one piece of food product to wet ingredients, the wet ingredients absorbing into the food product.

11. The method of claim 10, wherein marinating further comprises introducing the at least one piece of food product to dry ingredients, the dry ingredients coating at least an outer surface of the at least one piece of food product.

12. The method of claim 9, wherein the food product is plant-based.

13. The method of claim 9 wherein vacuum sealing further comprises lowering the temperature of the at least one piece of food product to within a predetermined temperature range.

14. The method of claim 11, wherein the applied heat causes a Maillard reaction and between the dry ingredients and the food product.

15. The method of claim 9, wherein the temperature of the food product is lowered to within a predetermined temperature range after smoking and after sous vide cooking.

16. The method of claim 9, wherein the food product is meat.

17. A pre-packaged food product comprising:
vacuum sealed food product, wherein prior to the vacuum seal the food product was marinated, seared, and smoked, and wherein after the food product was vacuum sealed it was sous vide cooked in steam.

18. The pre-packaged food product of claim 17, wherein when the temperature is lowered to within a predetermined temperature range, the vacuum sealed food product can be stored for at least 60 days at temperatures of about 40° F. and for at least 365 days at temperatures of about 0° F. without compromising the quality or integrity of the meat.

19. The pre-packaged food product of claim 17, wherein the food product has undergone a Maillard reaction.

20. The pre-packaged food product of claim 17, wherein after the sous vide cooking, the food product is edible after the vacuum seal is broken and the food product is heated.
